(19) United States
(12) Patent Application Publication
(10) Pub. No.: US 2009/0273660 A1
(43) Pub. Date: Nov. 5, 2009

(54) Electronic Frame for a Flat-Screen Television

(76) Inventors: Paul Regen, Felton, CA (US); Peter Garrett, Aptos, CA (US)

Correspondence Address: CENTRAL COAST PATENT AGENCY, INC, 3 HANGAR WAY SUITE D, WATSONVILLE, CA, 95076, US

(21) Appl. No.: 12/435,544

(22) Filed: May 5, 2009

Related U.S. Application Data
(60) Provisional application No. 61/050,530, filed on May 5, 2008.

(51) Int. Cl. H04N 7/14; H04N 5/64; H04N 5/44

(52) U.S. Cl. 348/14.02; 348/836; 348/734; 348/E05.128; 348/E05.096; 348/E07.078

(57) ABSTRACT

A television frame for a flat-screen television has a length dimension, a width dimension and a frame depth such that the frame fitted onto the flat-screen television frames the screen of the television in a symmetric fashion, and a control module with a wireless transceiver affixed to the frame for enabling wireless communication with a personal computer including the transmission of media from the personal computer to the television, the control module including input ports and output ports for functionally integrating the television and the frame.

### CROSS-REFERENCE TO RELATED DOCUMENTS

The present application claims priority to provisional application Ser. No. 61/050,530, filed on May 5, 2008. The 61/050,530 application above is incorporated in its entirety herein by reference.

### BACKGROUND OF THE INVENTION

1. Field of the Invention

The present invention is in the field of television electronics and pertains particularly to methods and apparatus for camouflaging a wall-mounted flat-screen television.

2. Discussion of the State of the Art

Flat-screen televisions, also termed flat-panel televisions, are becoming thinner as new television screen technology is developed. Many flat-screen televisions are mounted on a wall because of the thin profile and lighter weight of the television. Wall mounting eliminates that need for a complex entertainment center.

Wall mounting saves space and is a convenience to users, however many users do not like the look of a large television mounted on their wall. Another problem with televisions in general including flat-screen televisions is that subtle eye stress may be caused by the constant fluctuation of light on the retina of a user when watching television in a dark room. While home-theater lighting systems are available on the market, these systems are installed separately increasing cost of the entertainment system. Moreover, moving the television to another wall is impractical especially if a lighting system has been installed in the wall supporting the entertainment system. Although there are techniques for hiding wires and equipment including use of wireless speaker systems, conventional means for blending the look of a wall-mounted television with the decorum of a host room are ad-hoc at best and fall short of achieving that goal.

Therefore, what is clearly needed is a system for disguising or camouflaging a wall-mounted flat-screen television for improvement of aesthetic appeal, including a mechanism for providing a back-lighting system for easing strain on the eyes of users watching the television.

### SUMMARY OF THE INVENTION

A problem stated above is that flat-panel televisions, also termed flat-screen televisions are being developed that are increasingly thinner and lighter such that they may be wall-mounted more conveniently with less hardware, but consumers often do not like the way the television looks mounted on the wall. Methods have been developed to hide or eliminate speaker wires and to make other equipment connected to the television look more natural but conventional means of presenting the television on the wall still fail to adequately camouflage the television so that it fits in with the decorum of the room. Furthermore, many wall-mounted flat-panel televisions do not have the benefit of theater lighting or back lighting, which is typically installed separately from the television and cannot be easily moved to another location.

The inventors searched functional elements of flat-screen televisions and electronic components looking for elements that exhibit a potential for interoperability that might be incorporated to produce a wall-mount presentation for a flat-panel television that is more appealing to view in conjunction with room decorum.

The inventors realized during an inventive moment that if a functional electronic frame could be provided and could be electronically integrated with a flat-panel television significant artistic appeal and functional improvement in television viewing might result.

Accordingly, in an embodiment of the present invention, a system for a flat-screen television is provided. The system has a frame having a length dimension, a width dimension and a frame depth such that the frame fitted onto the flat-screen television frames the screen of the television in a symmetric fashion, and a control module with a wireless transceiver affixed to the frame for enabling wireless communication with a personal computer including the transmission of media from the personal computer to the television, the control module including input ports and output ports for functionally integrating the television and the frame.

In one embodiment the television frame is made of a lightweight polymer composition and includes at least one detachable faceplate covering an area at least equal to the front surface area of the frame. In this embodiment the faceplate is decorative and modular, the faceplate representing an artistic finish for the frame.

In one embodiment the media is a digital image sized to fit the television screen. In one embodiment the control module further includes a radio frequency (RF) remote control receiver. In one embodiment the television frame further includes a plurality of lighting fixtures pivotally mounted on the rear face of the frame the fixtures arrayed linearly about the frame, the angle of pivot of the fixtures controllable by a remote control communicating with the RF receiver to control pivot motors installed in the fixture mounts. In this embodiment each lighting fixture includes a plurality of light sources the intensity thereof controllable by the remote control. In a variation of this embodiment the light sources are light emitting diodes (LEDs). In another variation the light sources are organic light emitting diodes (OLEDs).

In one embodiment the system further includes a bay for docking a memory card containing one or more digital photos for display on the television screen. In one embodiment the system further includes a digital display screen covering the area of the front face of the frame and ported to the control module. In this embodiment artistic digital frame patterns are available on the personal computer for wireless upload to the digital display screen for display. In one embodiment wherein light fixtures are provided, the television frame further includes a light sensor and a switch for tripping the light sources to turn on in low light conditions.

In one embodiment wireless communication is one of wireless fidelity (WiFi) or Bluetooth. In a variation of this embodiment the television frame further includes a video camera and at least one microphone for enabling bidirectional audio and video for a wireless telephony application executed on the personal computer and using the television as the communication interface on a wide area network (WAN). In another variation to this embodiment the WAN is the Internet network.

In one embodiment where lighting fixtures are provided, the system further includes a light intensity sensor for detecting the intensity of light emitted from the television screen and a light intensity regulator for regulating the intensity of the light sources according to readings of light intensity sensor. In one embodiment wherein lighting fixtures are provided the angle of pivot is individually controllable for each lighting fixture.

In one embodiment where at least one faceplate is provided the at least one faceplate is manufactured of aluminum and painted to resemble a natural wood. In another embodiment the at least one faceplate is manufactured of a soft metal and is engraved with an artistic pattern.

### BRIEF DESCRIPTION OF THE DRAWING FIGURES

FIG. 1 is a front elevation view of a flat screen television framed according to an embodiment of the present invention.

FIG. 2 is a rear elevation view of the framed television of FIG. 1 according to an embodiment f the present invention.

FIG. 3 is an end view of a pivotally mounted lighting fixture of FIG. 1 illustrating pivotal motion according to an embodiment of the present invention.

FIG. 4 is a perspective view of a flat screen television frame according to another embodiment of the invention.

FIG. 5 is a perspective view of the control module of FIG. 2 according to an embodiment of the present invention.

### DETAILED DESCRIPTION

The inventors provide a system and methods for disguising or camouflaging a wall-mounted flat-screen television to improve aesthetic appeal of the room containing the television, and a mechanism for providing backlighting for the television for improving television watching for users and for reducing strain on the eyes of users. The present invention is described in enabling detail in the following examples, which may represent more than one embodiment of the invention.

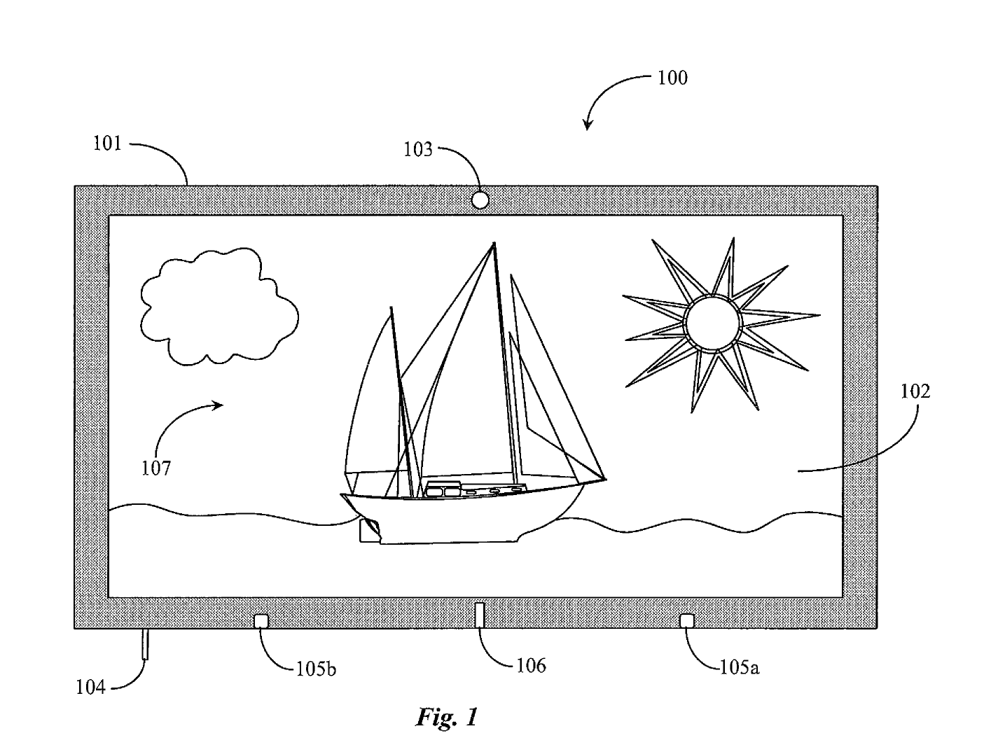

FIG. 1 is a front elevation view of a wall-mounted flat-screen television with a frame according to an embodiment of the present invention. A framed flat-screen television system 100 is illustrated in this example and may be assumed mounted on a wall for discussion purposes. Camouflaged system 100 includes a television frame 101 and the flat-screen television 102.

Frame 101 may be manufactured of wood, metal, polymer, or some other durable, but lightweight material. In some embodiments different materials are preferred for artistic consideration and practical reasons. In this example frame 101 is one contiguous piece having an overall length dimension and a width dimension visible in this front elevation view. The inside length and width dimensions of frame 101 are such that the frame fitted onto flat-screen television 102 frames the viewing screen of the television in a symmetric fashion.

In one embodiment frame 101 is manufactured of varying frame sizes to fit different sizes of flat-screen televisions. In one embodiment frame 101 has an inside frame length and width just large enough to be snuggly fitted over flat-screen television 102 with no “play” so that it stays on the television after being fitted over the television. In one embodiment television frame 101 is mounted to a flat-screen television such as television 102 using available mounting hardware such as nuts and bolts, screws, or other fastener systems.

In one embodiment frame 101 is manufactured in separate pieces that are fitted together at the corners to assemble a full frame. In another embodiment, television frame 101 may be slidably adjustable both in length and height allowing the frame to be fitted over more than one size of television by loosening the adjustment mechanisms and then re-tightening them after a fit has been accomplished. In the case of an adjustable frame 101 different adjustment mechanisms may be available such as overlapping tracked construction for both length and width.

In one embodiment of an adjustable frame 101, center tracks might be provided at the center of each side of the frame. Turn knobs using a friction contact stop mechanism might be provided to lock the frame at a specific size. The depth of frame 101 (not visible in this view) may vary, but shall be sufficient to make stable contact with the outside surfaces of the television such that the framing lies in a same or parallel plane as the television-viewing screen.

Television frame 101 may be decorative on its face such as sporting the look of a specific finished wood frame like cherry, oak, or walnut, etc. In one embodiment the face of frame 101 might sport a smooth finish and a solid color or multiple colors. In another embodiment where the frame is metal, a specific metallic finish or engraving might be applied. 11 In one embodiment of the present invention frame 101 includes a digital display screen covering the area of the front face of the frame and ported to the control module. The digital display screen may be an OLED screen or another known screen type. In this embodiment artistic digital frame patterns may be available on the personal computer for wireless upload to the digital display screen for display. Digital frame patterns may also be downloaded from a network. In a variation to this embodiment a user may create a digital frame pattern for upload to frame 101 from a digital photograph. Frame 101 is electronically integrated with flat screen television 102, in a preferred embodiment, details of which are provided later in this specification.

Functioning as an electronic peripheral to television 102, frame 101 may include one or more built-in electronic components. In a preferred embodiment frame 101 includes a control module (not illustrated) with a wireless transceiver, a portion of which is visible in this example as wireless transceiver antennae 104. In this example frame 101 includes an optional video camera 103 and one or more microphones 105a and 105b. A wireless transceiver antenna 104 is part of a control module not visible in this view but illustrated in detail later in this specification.

Television frame 101 including video camera 103 and at least one microphone (105a, b) is in this example enabled for bidirectional audio and video for a wireless telephony application executed on a personal computer. In this case the PC operator uses the television as the communication interface on a wide area network (WAN). In one embodiment the WAN is the Internet network.

Wireless capability enables flat-screen television 102 to be coupled wirelessly to a personal computer also having wireless capability. In this way applications executed from a personal computer may display on television 102, and audio and video integration enables frame 101 to support video and audio consistent with communications applications executed from the computer. For example, a user may practice voice over Internet protocol (VoIP) telephony from a personal computer using television 102 as a display monitor. Video camera 103 and microphones 105a and 105b support audio and video for a telephony application operated from a personal computer coupled to television 102 through electronic integration via the above-mentioned control module using wireless technology.

Television frame 101 includes a light sensor 106 in one embodiment where a backlighting system (not illustrated) is provided on the rear surface of the frame. In this example light sensor 106 detects light levels emitted from the screen of television 102 and subsequently adjusts the intensity of a backlighting system installed on the backside of the frame. More detail about a backlighting system and the use thereof in accordance with an embodiment of the present invention is provided later in this specification.

In one embodiment of the present invention television frame 101 is integrated with television 102 via a control module as described further above such that a user operating a personal computer with wireless capability may send media data to television 102 for display on the television screen using the wireless connection enabled through the wireless transceiver of the control module. In this way a photograph or video data may be uploaded for display on the television screen of television 102 from the computer. In this example, a photograph 107 is in a state of display on the television screen of television 102.

Photograph 107 may be uploaded to frame 101 via the control module and wireless transceiver and displayed on the television screen when television 102 is not in use. In this way further camouflage is afforded wherein system 100 is made to emulate a framed painting or photograph hanging on the wall. In this embodiment it is not readily apparent to an onlooker that system 100 is a television system and not simply a painting or framed work of art.

It will be apparent to one with skill in the art that the television frame of the present invention may include other features that are illustrated in this example as well as fewer features than are illustrated without departing from the spirit and scope of the present invention. For example, video camera 103 and microphones 105a and 105b are not necessarily required in order to practice the present invention.

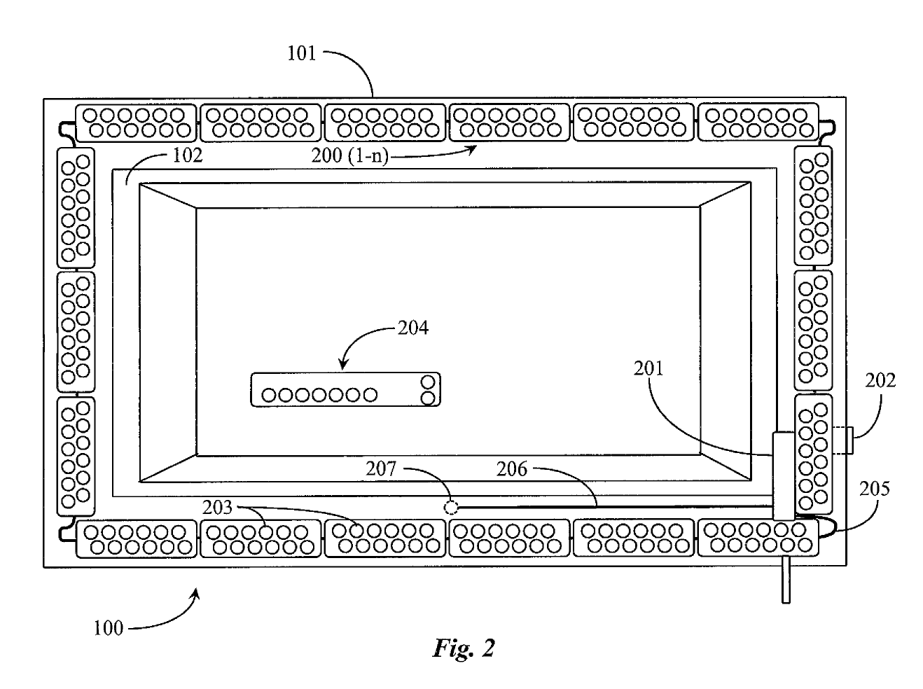

FIG. 2 is a rear elevation view of the framed television system 100 of FIG. 1 according to an embodiment of the present invention. Frame 101 is fitted around and over flat-screen television 102 as previously described above. The rear face of television 102 is visible in this view and includes a television interface panel 204. Panel 204 may very in configuration and number of input ports depending on the make and model of the flat-screen television, but generally the interface includes at least high definition (HD) input ports, audio input ports, and a coaxial cable input port. For example, some models include universal serial bus (USB), and IEEE cable input ports and a high definition multimedia interface (HDMI) port. In this example, a control module 201 is provided and is affixed to the rear surface of television frame 101. Control module 201 includes a wireless transceiver as previously described. Control module 201 further includes HD, audio, and coaxial input ports as well as output ports for integrating the television to the frame via the control module.

Television frame 101 has a plurality of lighting fixtures 200 (1-n) pivotally mounted on the rear face of the frame with the fixtures arrayed linearly about the frame. The angle of pivot of the fixtures is in one embodiment controllable by a remote control communicating with an RF receiver illustrated herein as RF remote sensor 207 provided in the construction of the frame. Using a remote control device, a user may change the angle of pivot of the lighting fixtures and may in one embodiment control the intensity of light emitted from light sources illustrated herein as light sources 203 that are mounted on the fixtures. More detail about pivot capability of lighting fixtures 200(1-n) is provided later in this specification.

Lighting fixtures 200 (1-n) are connected together in series from the point of control module 201 by way of electrical conduit 205. Conduit 205 may include one or more power lines for illuminating lighting sources 203 and for powering pivot motor components (not illustrated). Electrical conduit 205 connects all of the lighting fixtures together in this example. A sensor control line 206 is provided from control module 201 to RF remote sensor 207 for sending control signals to and receiving control signals from the remote sensor. In one embodiment input to sensor 207 is relayed via control module 201 to the lighting fixtures for adjusting the angle of pivot and for adjusting the light intensity emitted by the light sources of the fixtures. Light sources 203 may be light emitting diodes (LEDs), organic light emitting diodes (OLEDs), or just plain light bulbs. Lighting sources 203 may be of varying colors, of one color, or just plain white lighting sources.

There may be fewer or more lighting fixtures 200 (1-n) provided to frame 101 than what is illustrated in this example without departing from the spirit and scope of the present invention. Likewise, there may be fewer or more lighting sources 203 provided to each lighting fixture than what is illustrated herein without departing from the spirit and scope of the present invention. In this example lighting fixtures 200 (1-n) may be enabled to pivot inward towards television 102 or outward towards the edge of frame 101. In one embodiment the optical light sensor 106 of FIG. 1 can detect light emanating from the screen of television 102 and may provide the control module 201 with data for adjusting the intensity of light emanating from lighting sources 203 in real time. In another embodiment light sensor 106 of FIG. 1 detects when there are lower levels of light in the room hosting system 100 and may, according to some pre-set threshold, trigger the system to turn on and off the backlighting system of fixtures 200 (1-n).

Television frame 101 includes a bay for a memory card in this example. Memory card bay 202 is illustrated with a memory card plugged in. Memory card bay 202 has a power and control line connection (not illustrated) to control module 201. In this embodiment a user may display pictures or other media on the screen of television 101 when the television is not otherwise in use. In this way a connected PC is not necessary to camouflage the television with a picture to resemble a painting or a framed photograph. The media can be uploaded to display from the card bay using a remote control device.

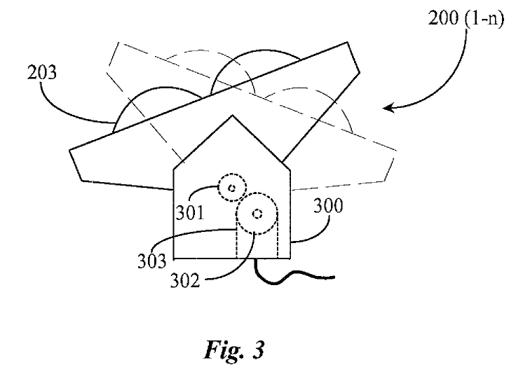

FIG. 3 is an end view of a pivotally mounted lighting fixture 200 (1-n) of FIG. 1 illustrating pivotal motion according to an embodiment of the present invention. Lighting fixture 200, which may be any of the fixtures 200 (1-n) of FIG. 1 is pivotally mounted, in this example, to a shaft housing 300 affixed to the surface of the television frame by any conventional method such as by nut and bolt, screws, adhesive, or other fastening methods and hardware. In one embodiment shaft-housing 300 comprises two end pieces spaced apart at just past the length of the lighting fixture. Shaft housing 300 supports an elongate pivot shaft 301 to which lighting fixture 200 (1-n) is attached. Pivot shaft 301 may be press fitted into fixture 200 (1-n) through an opening provided for the purpose.

Pivot shaft 301 is engaged by a gearwheel 302 mounted to a motor base 303. In one embodiment every lighting fixture 200 (1-n) is pivotally mounted in the described manner. Motor base 303 may contain one or more conventional switches (not illustrated) that when tripped cause gearwheel 302 to rotate in a clockwise or counterclockwise motion thereby turning pivot shaft one way or the other way to achieve an angle of pivot suited for the purpose. The exact angle of pivot of the fixture may vary depending on the total pivot range possible in both directions and information from the remote control operated by a user. In one embodiment there may be one or more default pivot angles programmed into the system at the control module wherein the user operating the remote control is enabled to select which angles are desired for all of or for each of the lighting fixtures.

Lighting fixture 200 (1-n) may be manufactured of a durable polymer that is light in weight. Shaft housing 300 may also be manufactured of a lightweight and durable polymer. Fixture 200 (1-n) and shaft housing 300 may be manufactured by molding. Pivot shaft 301 may be manufactured of stainless steel, aluminum, or a durable polymer material. Shaft 301 may have grooves provided along the length thereof and equally spaced around the shaft. Gearwheel 302 may be manufactured of stainless steel, aluminum, or a durable polymer. Gearwheel 302 may have gear teeth provided in an equally spaced pattern about the wheel. The gear teeth engage the grooves provided in the pivot shaft enabling control over motion of the shaft and therefore the angle of pivot of the lighting fixture.

In one embodiment of the invention all of the fixtures may be pre-set by a user to respond to one command and pivot in unison. In another embodiment the fixtures may be pre-set to pivot individually or in groups such as all of the fixtures on one side of frame 101 pivoting to a first specified angle of pivot and all of the fixtures on the opposite side pivoting to a second specified angle of pivot where the fixtures of each group pivot in unison. There are many variant configuration possibilities.

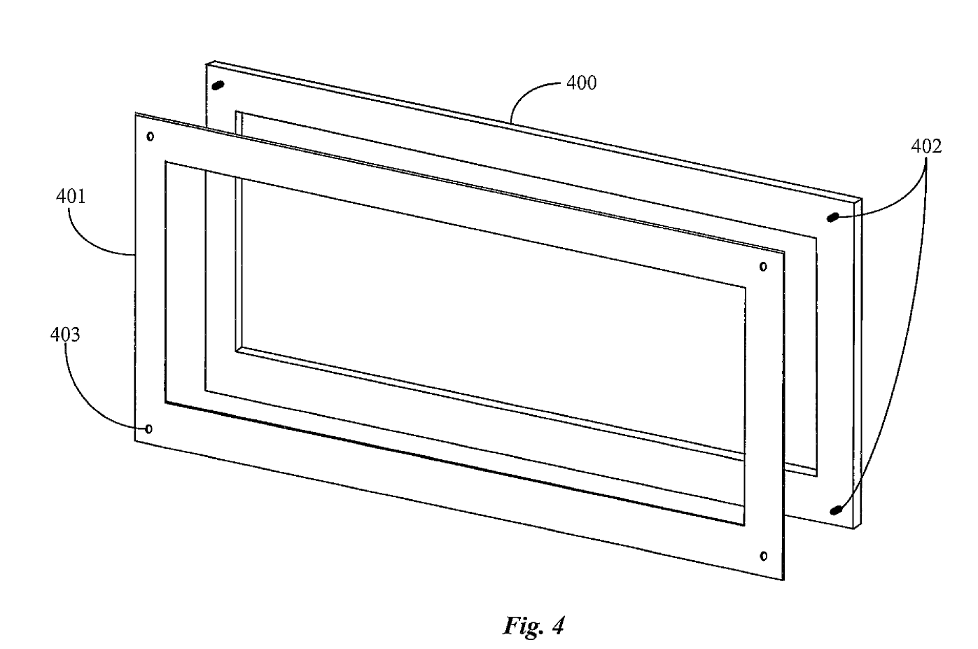

FIG. 4 is a perspective view of a flat-screen television frame according to another embodiment of the invention. In this embodiment, the television frame is provided in two pieces. These are a frame base 400 and a frame faceplate 401. Frame base 400 may be manufactured of a durable lightweight material such as a polymer material or lightweight metal. Faceplate 401 may be manufactured of a lightweight metal like aluminum, tin, or of some other material that may be modified with a finish, paint, brushwork, or metallic engraving.

Faceplate 401 is adapted in this example to be fastened to frame base 400 using snap studs 402. Other fastening hardware may be used in place of studs 402 such as clamps, nuts and bolts, screws or other conventional methods. In this example, openings 403 are provided through the surface of faceplate 401 to receive snap studs 402 such that when aligned and pressed onto frame base 400, faceplate 401 may be snapped into position flush with the frame base. In this example faceplate 401 may be decorative and modular, the faceplate representing an artistic finish for the frame.

Faceplate 401 may be detached from frame base 400 and replaced with anther faceplate of a different artistic style. In one embodiment the faceplate 401 is manufactured of aluminum and painted to resemble a natural wood. In another embodiment faceplate 401 is manufactured of a soft metal and is engraved with an artistic pattern. In another embodiment more than one modular faceplate is provided such as one for each side of frame base 400 the faceplates manufactured to adjoin at the corners.

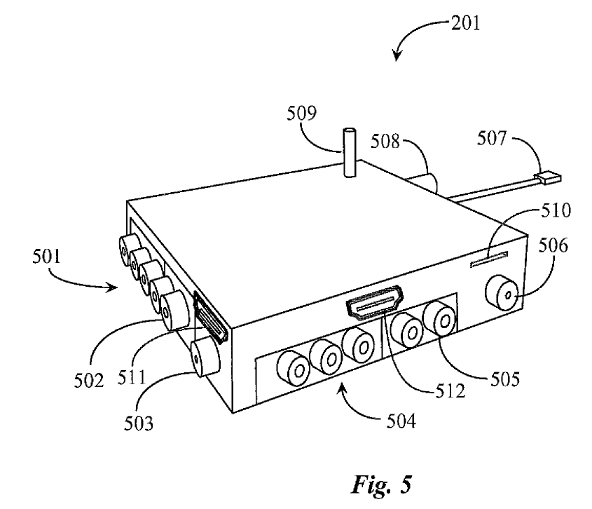

FIG. 5 is a perspective view of control module 201 of FIG. 2 according to an embodiment of the present invention. Control module 201 may include all of the required electronics for integrating frame 101 to flat-screen television 102. Control module has a digital medium installed thereon and adapted to store software and or firmware for providing user-initiated control over television 102 and frame 101.

Control module 201 has a plurality of HD input ports 501 corresponding generally to a like number of HD output ports illustrated herein as output ports 504. Corresponding audio ports are illustrated herein as input audio port 502 and output audio port 505. Corresponding coaxial ports are illustrated herein as an input coaxial port 503 and an output coaxial port 506. A user may integrate frame 101 (FIG. 2) to flat-screen television 102 (FIG. 2) by connecting the output cables from supporting peripheral electronic components such as cable boxes, satellite boxes, sound systems, etc. into HD input ports 501 including audio input port 502 and coaxial input port 503.

The output ports including HD output ports 504, audio output port 505, and coaxial output port 506 may be patched over to the television input interface panel completing the integration. Input and output ports of control module 201 may include an HDMI input and output port, illustrated herein as ports 511 and 512 respectively, providing a digital alternative to ports like super video (S-video) ports, coaxial cable ports, and video graphics array (VGA) ports. In one embodiment a set-up program (not illustrated) may be provided and may include set-up operations and configuration options performed by remote control after all of the cables are properly ported. It is noted herein that some ports of control module 201 may not be used depending on the make and model of television system the module is integrated with.

The inventor intends that any necessary type of port generic to a flat screen television system has a counterpart input and output port on control module 201 in order to enable modularity of control module 201 with respect to a wide variety of flat screen television systems. There may be fewer or more input and output ports provided to control module 201 than are illustrated in this example without departing from the spirit and scope of the present invention.

Control module 201 includes all of the electronic circuitry for enabling send and receive of digital data and media over a wireless network enabled by the wireless transceiver built into the module. A wireless transceiver antenna 509 is provided for improving wireless reception. In one embodiment control module 201 includes an RF remote module for sensing remote control commands issued by an associated remote control and for controlling movement of the lighting fixtures termed in aggregate an ambient light bar by the inventors and light intensity and perhaps color emitted from the lighting sources on the fixtures. In one embodiment RF remote module 507 communicates with remote sensor 207, which detects the signals sent by an associated remote control device operated by a user.

Control module 201 includes a power cord 508 that may be plugged into an alternating current outlet to power the control module. It is noted herein that control module 201 may further include an on/off switch and other like user controls without departing from the spirit and scope of the present invention. In one embodiment control module 201 includes a slot 510 for an SD card. Control module 201 may also be subject to a booting routine that executes every time the unit is powered on after being powered off. The present invention is not limited to an aftermarket product for flat-screen televisions. In one embodiment new flat-screen televisions may be manufactured including the frame and control module of the present invention.

It will be apparent to one with skill in the art that the framed flat-screen television system of the invention may be provided using some or all of the mentioned features and components without departing from the spirit and scope of the present invention. It will also be apparent to the skilled artisan that the embodiments described above are specific examples of a single broader invention, which may have greater scope than any of the singular descriptions taught. There may be many alterations made in the descriptions without departing from the spirit and scope of the present invention.

What is claimed is:

1. A system for a flat-screen television comprising:
a frame having an inside length dimension, an inside width dimension and a depth such that the frame fitted onto the flat-screen television frames the screen of the television in a symmetric fashion; and
a control module with a wireless transceiver affixed to the frame for enabling wireless communication with a personal computer including the transmission of media from the personal computer to the television, the control module including input ports and output ports for functionally integrating the television, the computer and the frame.

2. The system of claim 1 made of a lightweight polymer composition and including at least one detachable faceplate covering an area at least equal to the front surface area of the frame.

3. The system of claim 2 wherein the faceplate is decorative and modular, the faceplate representing an artistic finish for the frame.

4. The system of claim 1 wherein the media is a digital image sized to fit the television screen.

5. The system of claim 1 wherein the control module further includes a radio frequency (RF) remote control module.

6. The system of claim 5 further including a plurality of lighting fixtures pivotally mounted on the rear face of the frame the fixtures arrayed linearly about the frame, the angle of pivot of the fixtures controllable by a remote control communicating with the RF receiver to control pivot motors installed in the fixture mounts.

7. The system of claim 6 wherein each lighting fixture includes a plurality of light sources the intensity thereof controllable by the remote control.

8. The system of claim 7 wherein the light sources are light emitting diodes (LEDs).

9. The system of claim 7 wherein the light sources are organic light emitting diodes (OLEDs).

10. The system of claim 1 further including a bay for docking a memory card containing one or more digital photos for display on the television screen.

11. The system of claim 1 further including a digital display screen covering the area of the front face of the frame and ported to the control module.

12. The system of claim 11 wherein artistic digital frame patterns are available on the personal computer for wireless upload to the digital display screen for display.

13. The system of claim 7 further including a light sensor and a switch for tripping the light sources to turn on in low light conditions.

14. The system of claim 1 wherein wireless communication is one of wireless fidelity (WiFi) or Bluetooth.

15. The system of claim 14 further including a video camera and at least one microphone for enabling bidirectional audio and video for a wireless telephony application executed on the personal computer and using the television as the communication interface on a wide area network (WAN).

16. The system of claim 15 wherein the WAN is the Internet network.

17. The system of claim 7 further including a light intensity sensor for detecting the intensity of light emitted from the television screen and a light intensity regulator for regulating the intensity of the light sources according to readings of light intensity sensor.

18. The system of claim 6 wherein the angle of pivot is individually controllable for each lighting fixture.

19. The system of claim 2 wherein the at least one faceplate is manufactured of aluminum and painted to resemble a natural wood.

20. The system of claim 2 wherein the at least one faceplate is manufactured of a soft metal and is engraved with an artistic pattern.
